(19) United States
(12) Patent Application Publication
(10) Pub. No.: US 2018/0014516 A1
(43) Pub. Date: Jan. 18, 2018

(54) Forward Gliding and Upward Reversing Fishing Lure

(71) Applicant: Paul Marcus Van Reenen, Crystal River, FL (US)

(72) Inventor: Paul Marcus Van Reenen, Crystal River, FL (US)

(21) Appl. No.: 15/212,176

(22) Filed: Jul. 15, 2016

(51) Int. Cl. A01K 85/16; A01K 85/02; A01K 85/01

(52) U.S. Cl. CPC A01K 85/16; A01K 85/01; A01K 85/02

(57) ABSTRACT

A rigid, semi-rigid, or soft 3-dimensional, realistic appearing, artificial and aft tethered decapod lure comprising a head section, a tapered body section and a tail section with an up plaining, expanded fan-shaped tail. Each section exhibits ribbing that allows for visual and sonic characterization of the lure by predator fish. Lure sections are hollow and chambered to allow for weighting of the head and body section to encourage a forward and downward glide with lure casting and line slack. In opposite, the upward-plaining, fan-shaped tail acts as an upward, reverse motion mechanism with retrieval of the invention. The bi-directional motion capability of the lure allows the angler to utilize the lure in two ways, as a sub-surface sinking lure, attracting fish at various depths, or as a surface, top-water lure capable of replicating the actions of an escaping decapod under attack by a predatory fish.

### CROSS-REFERENCE TO RELATED APPLICATIONS

This application claims the benefit of Provisional Patent Application No. 62/192,814 filed Jul. 15, 2015.

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

### Field of the Invention

The present invention relates to an artificial fishing lure that is designed to more accurately mimic and portray the body shape and bi-directional movement of a natural decapod bait.

### Background of the Invention

In addition to the use of live bait, anglers have long relied upon a wide range of artificial baits to augment their success. Indeed, these artificial baits are as diverse and varied as the fishermen they serve. And while artificial baits are available in any number of shapes, sizes, and color permutations, each lure carries with it the singular objective of enhancing the probability that the fisherman will increase the odds of catching fish.

Among artificial baits, though, few lures have been more widely produced than that of a simulated decapod in the form of artificial shrimp, prawns, and crawfish. In terms of fundamental design, the decapod possess a rounded head section followed by, and attached to, a similarly rounded, and tapered, flexible tail section. This tail section terminates in the expression a fan/paddle shaped tail and is the live decapods primary mode of locomotion. Additionally, decapods express a pair of eyes raised up on flexible stalks, in the form of antennae, and a plurality legs (with the crayfish additionally displaying terminally affixed pincers). It is these anatomical features and appearances, together with the decapod's natural movements, including a meandering forward position for feeding and a rapid erratic, upward and rearward escaping response, that aid in enhanced predator fish recognition. Consequently, the higher the degree of success in designing a decapod that is both natural appearance and movement will equate into increased predator strikes and ultimately fish caught.

Plainly, a large number artificial decapod lures exist n the commercial, gaming and leisure fishing industries. And while many advances have been made in both appearance and movement, deficiencies remain that leave fisherman in need of a decapod lure that mimics the appearance of natural bait, encompasses the ability to glide forward upon casting, and the ability to reverse upward upon retrieval.

Clearly, improvements have been made in the appearance of decapod lures and a natural progression can be seen from the earliest patents to Royston (U.S. Pat. No. 2,334,792) and Roes (U.S. Pat. No. 3,079,723) to the more advanced patents issued to Nichols (U.S. Pat. No. 13,722,06). Yet, no lure encompasses the aesthetics of the present invention. Specifically, the segmented lure body of the present invention and the specific weight placement therewith are novel features that give rise to a more natural and life-like artificial lure. Additionally, the raised junctures between segments not only allow the lure to have a natural appearance, but also have the addition of the functional adjunct of the creation of vortices and perturbations in the water that are appreciated by the lateral lines of the prey fish. What is more, the lure demonstrates shading (a darker top and lighter bottom) to more closely resemble a decapod.

In terms of movement and action, previous inventions have correspondingly had limited success in mimicking the natural movements of the decapod. To the detriment of previous inventions, inventors have long followed the accepted trend of providing a line attachment point at the fore and upper head section of a decapod lure. See Nichols, U.S. Pat. No. 13/772,026, Ratzlaff U.S. Pat. No. 5,875,582, Snow, U.S. Pat. No. 3,377,734 A. While forward motion can be satisfied, the rearward escaping motion is denied and not possible. The present invention, conversely, uses the natural body and fan/paddle shaped tail together with a rear, and crucially ventral, line attachment to encourage a rearward and upward action terminating in the invention being able to breach the surface. Additionally, as can be seen in references U.S. Pat. No. 5,787,634 to Way and U.S. Pat. No. 2,334,792 issued to Royston, jointed shrimp lures possessing a hinged body, further display a top line attachment point proximal to the lure head. These designs once more may satisfy forward motion, however the rearward escape action and breaching of the surface is impossible (See also U.S. Pat. No. 3,079,723, issued to Roes, with line attachment through the carapace/head section)

Likewise, U.S. Pat. No. 8,793,924 issued to Hughes and U.S. Pat. No. 6,505,432 to Brinkman exhibit a line tethering position at the top and aft section of the head carapace. While the placement is different from those in the '026, '582, and '723 in that the Hughes and Brink an patents explain a reward, retreating lure, the '924 and '432 patents are just as incomplete as their predecessors in that they are incapable of forward movement. Moreover, neither patent entails a forward, gliding motion that is critical to the placement of the lure of the present invention.

Too, U.S. Pat. No. 4,516,352 issued to Firman, discloses a system with (1) a weighted hook attached to a soft Shrimp body and (2) reward line attachment. And, while the line does pass through the tail section, a forward gliding motion and upward ascend would not be possible. Granted, the invention differs from the above references cited in that the line attachment is located in the ventral/underneath area of the rounded tapered tail section at the approximate junction of the tail fan/paddle, but, given the absence of the plaining tail, proper manipulation of the frontward gliding with line release and reward, upward plaining (escaping action) cannot be achieved with line retrieval.

Finally, while each invention is capable of either forward motion or a reverse motion, none is capable of both. Plainly, each cited inventions lack the ability to (1) glide downward and (2) retreat upward do to structural insufficiency and an absence of the two primary structural components of the present invention—a upward planning tail and a line attachment inferior to the tail. These two components, together with an elongated, tubular design and discrete weight placement afford the present invention unique capabilities unparalleled in the lure industry.

While it is clear that a wide array of lure designs have been offered by a multitude of inventors, there remains an unmet need for a single lure that encompasses the ability to glide down and forward upon casting and reverse upward upon retrieval. Together with enhanced design features, it is the goal of the present invention to meet these needs.

### BRIEF SUMMARY OF THE INVENTION

The present invention provides a unique fishing bare that is constructed with a rigid, semi rigid or soft material, into a tubular body that consists of a downward plaining head section, an upward planting thoracic (mid) section, a downward plaining tail section, and an upward plaining fan-shaped tail. The head section exhibits two stalks upon which two spheres are adhered to simulate eyes. The head, thoracic, and tail sections encapsulate chambers that encompass weights to aid in casting and retrieval and in the simulation f realistic action and movement. Each section displays raised “ribs” that aid in a correct and recognizable visual profile and a sonic signature that is perceptible to predatory fish. The upward plaining tail functions to allow for forward gliding when casting into water and reward, upward movement upon retrieval. Line attachment is inferior to the tail and hooks are placed along the bottom of the lure along the sagittal plane. The physical features of the decapod are further accentuated through detailed shading with a darker dorsal section and a lighter ventral section.

### PREFERRED EMBODIMENTS OF THE INVENTION

In one embodiment, the lure that is the present invention is made to glide downward and forward with line release and in an upward and rearward escaping manner with line retrieval in a bi-directional manner. Retrieval is achieved when the angler would simply reel in the line and impart tension to create an automatic upward and rearward motion by the lure

In another embodiment, a highly desirable surface top-water action, referred to by fisherman as “Walk the Dog”, is possible with the present invention due to the upward planing action of the lure tail. Associated with this action is the placement of strategically correct weight into the chambers to give the lure an approximate, but not limited to an ‘8-o-clock-2-o-clock’ fore to aft angular tilted ratio on a clock face when placed in water. Secondly this allocation of increased forward weight results in a lure which not only casts further, but will resist the tendency to tumble and spin due to the weight forward design. The nose down position allows for an instant forward falling glide penetrating the water surface, When the line is under retrieve by the angler, this precipitates the rearward lift (mimicking retreat) and subsequently breaching the water surface. At this point the anger has the option of merely ‘popping’ the invention repeatedly, creating a series of surface splashes, allowing the invention to glide back downward, below the water line and to repeat the procedure. Or secondly the angler tray utilize a continuous stop start retrieve thus imparting a unique left to right, side to side action of the tail which would classically constitute the ‘Walk the Dog’ commonly employed by anglers.

In yet another embodiment, the Mare has adhered to its torpedo-shaped, rounded head and thoracic section appendages that are made to resemble a shrimp.

In another embodiment, the lure has adhered to its torpedo-shaped, rounded head and thoracic section appendages that are made to resemble a crawfish. Additionally, in this preferred embodiment, the lure that is the present invention may exhibit appendages that are pincers or claws that are forward facing and are made to appear as would a natural crawfish.

In another embodiment, the lure that is the present invention he invention is recommended to be between 85 mm-110 mm in length to fit the scope and spirit of this lure that is most practical to fish.

### BRIEF DESCRIPTION OF THE DRAWINGS

FIG. 1—Shows an enhanced side view with greater detail, together with a top view of the present invention, including a numbered list of the parts;

FIG. 2—Illustrates the desired position/angle of the artificial Shrimp/Crawfish lure when immersed in water. Together with a rear view of the illustrations of FIG. 1;

FIG. 3—Shows the invention in FIGS. 1 & 2 in two active positions marked A where the Shrimp/Crawfish lure has been casted out and slack line is given to allow for the downwards glide angle penetrating the surface to the predatory zone. B the same embodiment is shown being retrieved, creating the desired upward movement towards the surface and breaching the same;

FIG. 4—Illustrates the embodiment breaching the water surface through continued retrieve by the fisherman;

FIG. 5—Illustrates a top view of the highly desirable top-water fishing action termed and referred to as “Walk the Dog”. This action is attained through constant, brief, stop-start retrieval imparted to the fishing lure by the angler. The tail section of the invention will dart left to right, from side to side and backwards in distance increments decided upon by the fisherman;

FIG. 6—Illustrates the invention having been accentuated by careful painting to enhance the visual realism to both the predatory fish and the fisherman. In the rear view drawing an egg case has been painted to the bottom of the lure;

FIG. 8—Shows a collage of present day soft and hard artificial Shrimp/Crawfish lures with their respective line attachments points A. The invention is shown with line attachment B;

FIG. 9—Is a collection of three hard and rigid artificial Shrimp/Crawfish lures and their respective line attachment points and the invention marked B;

FIG. 10—Shows a close-up view of FIG. 9, once more showing the line attachment points A and B in greater detail.

### DETAILED DESCRIPTION OF THE INVENTION

The following detailed description of the embodiments is the best currently contemplated modes of carrying out exemplary embodiments of the present invention. The description should not be in a limiting sense, but rather made merely for the purpose of illustrating the general principals of the invention. The scope of the invention is best described by the appended claims and diagrams.

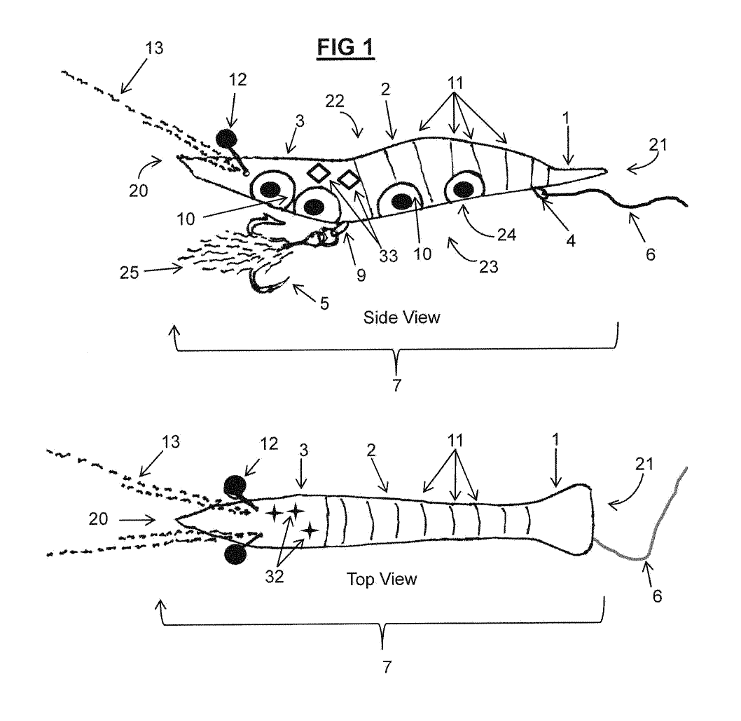

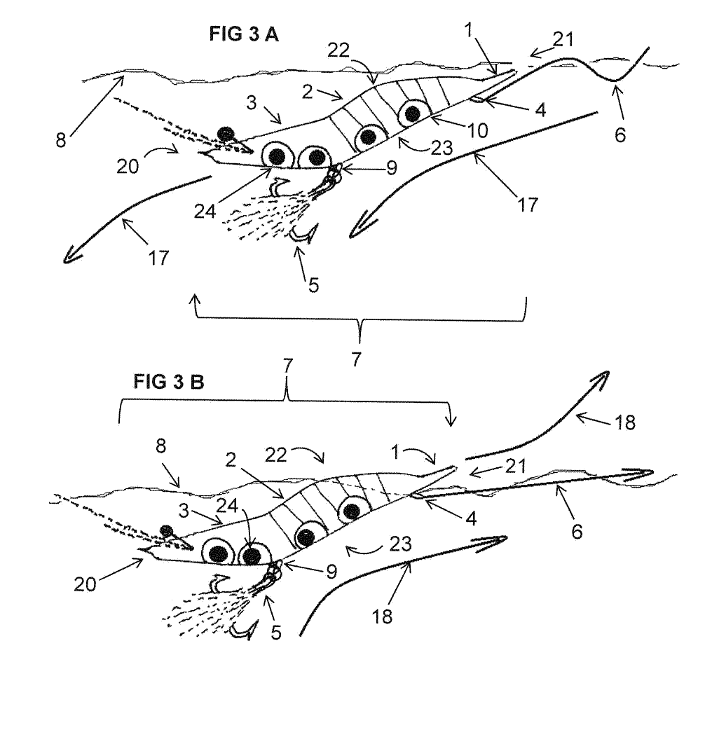

Broadly the embodiment 7 of the invention provides for an artificial Shrimp/Crawfish lure, FIG. 1-6 which is engineered and purposefully designed to mimic the swimming actions of the living critter. The following enhancements of the invention, a fan/paddle section 1, rounded tapered tail section 2, rounded head section 3, line attachment ring 4, hook or plurality of hooks 5, synthetic legs/appendages 25 attached to hook ring 5 but not limited to this location only, fishing line 6 attached to 4, water surface 8, strategically located hook attachment eye ring 9, weight chambers 10, cosmetic body segments 11, eyeballs on flexible stalks 12, cosmetic, synthetic flexible antennae 13, slack line 15 is shown in FIG. 3, line under retrieve 16 is shown in FIGS. 3 B, 4 and 5.

The forward and downward glide 17, and upward reversing action 18 are shown in FIGS. 3 A and B, fore section 20, aft section 21, top 22, bottom 23, internal weights 24, faux appendages represented by synthetic, flexible or natural filaments 25, optional darker shading of the top 30, accentuated carapace segments 31, optional internal or external glitter 32, optional internal luminescent beads 33, optional fluorescent painted tail 34 optional luminescent paint 35, and optional egg case 36 painted to bottom of tapered tail section represent a more realistic yet FAUX Shrimp/Crawfish lure for attracting more strikes from predatory fish.

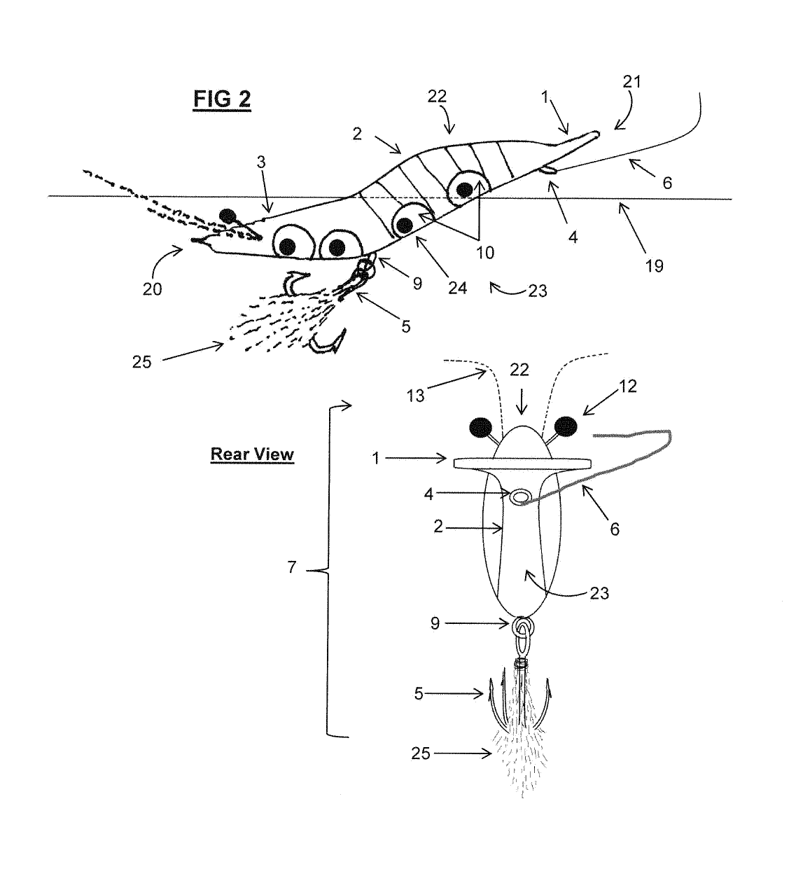

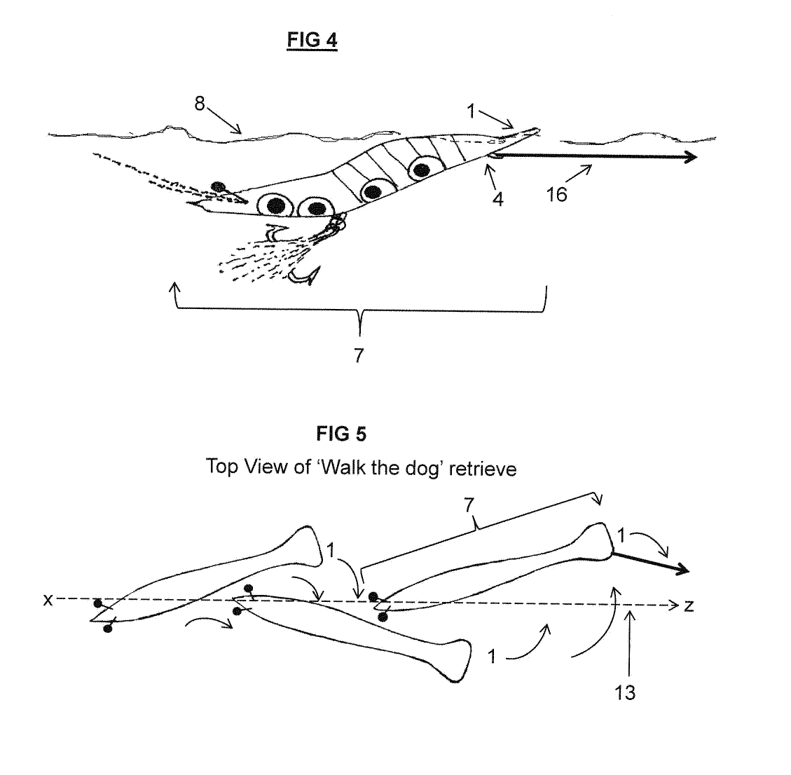

The noted individually numbered parts collectively form the complete invention marked 7 in FIGS. 1-6. It is well accepted that predatory fish through force of habit and actual memory will expect a threatened Shrimp/Crawfish using it's muscular tail section and expanded fan/paddle to rapidly attempt escape in a backwards and upwards direction. Anglers often observe Shrimp skipping across the water surface, evading predation. To mimic the actions of the living critter, the invention makes use of a head section 3, matched to a tapered tail section 2, attached to an expanded roughly triangular fan/paddle tail 1. Making a complete lure body. Careful weight selection 24 and their placement into internally located chambers 10 result in the invention assuming an 8-o-clock fore 20 and 2-o-clock aft 21 angle to the horizontal 19. See FIG. 2. This serves two functions, a smooth longer cast with no lure tumbling and the on gliding forward and downward 17 of FIG. 3 A, below the water surface 8 once he angler releases line 6. forward gliding is presumed since the tail fan/paddle tail 1 is tethered in the direction of the angler by the line 6 emanating from the angler. This action is assisted by the fan/paddle tail 1 acting as a wing, and the combination of head 3 and tapered body 2 acting as a fuselage. This action allows the angler to cast the invention close to a targeted area such as an overhanging tree, dock, moored boat, or undercut bank. Releasing line would enable the angler to access the shaded area where fish often lie in ambush. At the angler's discretion, the invention 7 can be retrieved in a suggestive manner. Retrieval of the line 6, FIGS. 3 B, 4 and 5 would result in the fan/paddle tail section 1 acting, as an upward and reversing 18 of FIG. 3 B planning board to the head 3 and tapered body section 2, effectively creating the illusion to the predator that this lure is evading predation. This action is well known to trigger a strike. Once the angler retrieves the invention until it breaches the water surface 8 FIG. 3 B, the angler may then continue a popping action and then release tension and repeat the entire process, or the angler may use the breaching action a continuous twitching action of the rod tip to move the lure in a highly effective manner referred to as “Walk the Dog”. See FIGS. 4 and 5.

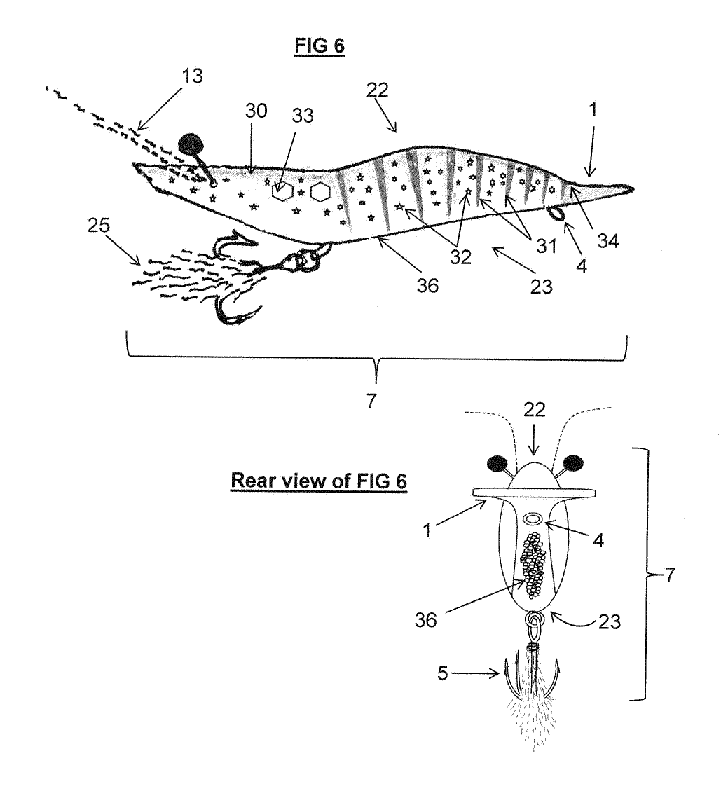

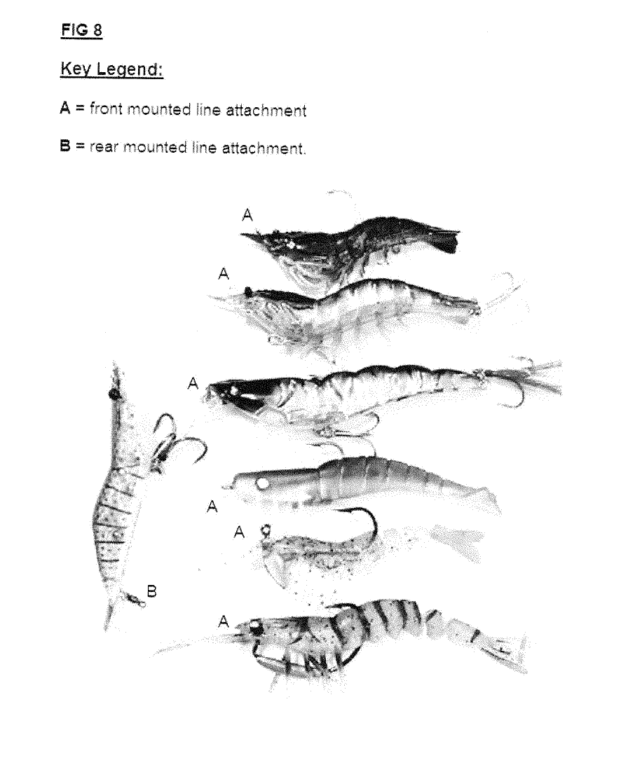

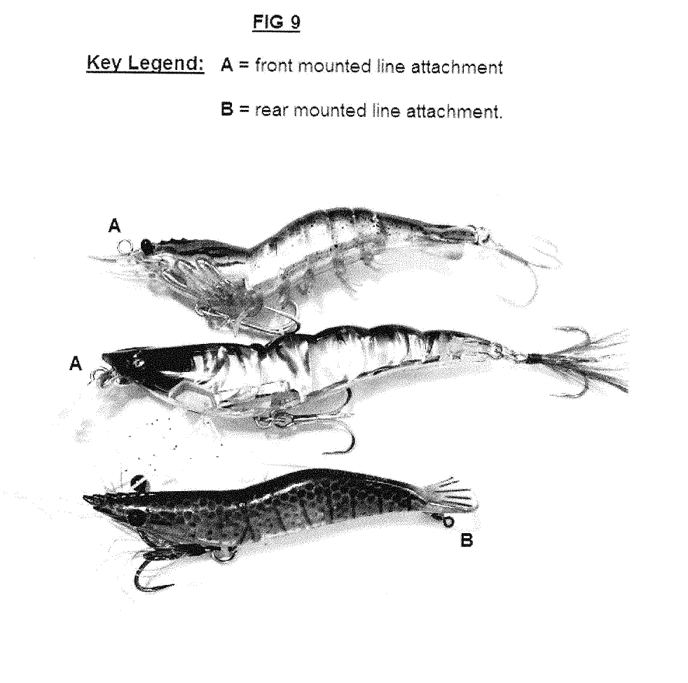

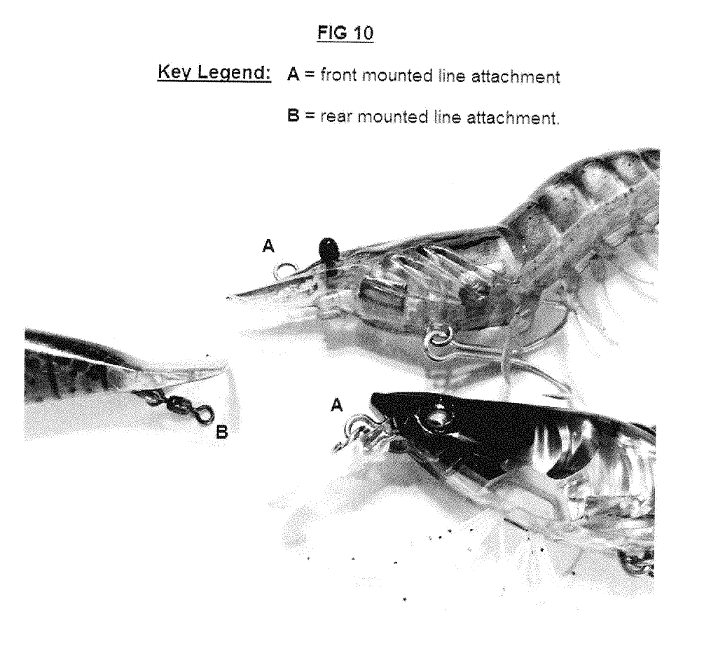

Vital to the correct functioning of the embodiment 7 is the placement of the lure attachment ring 4. The two rings, 4 and 9 respectively may be arranged ‘in-line’ as opposed to transverse as illustrated in FIG. 1-6. Hook ring 9 may be arranged as a single hook ring or plurality of hook rings. The invention places ring 4 located at the approximate junction of the tapered tail 2, and the fan/paddle 1, on the bottom side 23. Without this line attachment ring placement 4, this invention would fail in its function to rise upwards and to breach the water surface 8. The hook 5 attachment ring 9 is located at the approximate bottom 23 junction of the head 3, and tapered tail section 2 of the lure body. Attaching filaments 25 to the hook 5 gives the appearance of faux appendages. These filaments have an added benefit to the invention, in that under retrieve the water friction on the filaments lifts the hook 5 into a position immediately under the head 3 and toward the fore section 20. When a fish strikes the lure, the hook points are thus inside the predators mouth as it's jaws clamp over the lure, Numerous enhancements. to the embodiment 7 may be made in keeping with the spirit and scope of the invention. A body length approximated to 85 mm and 110 mm is deemed most practical to actually match the Shrimp/Crawfish in sizes. Antennae 13, eyes 12, are added to the head section 3 in a position, length and size to most acceptably represent the living critter. The addition artistic painting FIG. 6 is recommended to further deceive the intended predator. Luminous beads 33 or luminescent paint 35, fluorescent paint 34, glitter 32, darker shading 30 at the top, accentuated carapace segmentation 31, and an egg casing 36 may be added. Assembly of the individual parts is best executed using a firm synthetic body material, provided that the hook wire 9 and line attachment wire 4, exhibit acceptable structural integrity, and do not fail under reasonable fishing pressure. A lure body wall thickness of 1.5 mm is suggested by the inventor as providing the most efficient rigidity. On a larger physical scale the invention nay have heavier weights in the weight chambers to increase diving rate and depth. In another application the weights may be omitted to create a lure which floats or merely suspends in the water column, neither sinking nor floating. The placement locations and shape illustrated are not limited to these exact areas and shapes exclusively, and may be repositioned and reshaped internally to further enhance the invention. The weights 24 may be shaped to fit loosely in the weight chambers 10 creating a ‘rattling or knocking’ sound when the invention is utilized.

In yet another application, the fan/paddle tail 1, is not restricted to a rounded triangle. While the current shape is deemed most practical, the fan/paddle shaped tail may be clover leafed, rounded, square, even nature identical to the living critter.

In yet another embodiment, the antennae 13, and filaments 25 may he of a synthetic elastomer material attached to the head section 3, at a point fore 20 of the eyes and filaments placed on the bottom 23 of the same head section 3. Means of attachment should be by means of a transparent waterproof adhesive.

In yet another embodiment, the eyes 12 may have a clear eyeball, which is attached to the applicable head section 3 by means of a transparent water proof adhesive.

In yet another application, a plurality of hook attachment rings 9, for additional hooks may he included, in the invention

In yet another application, while this invention utilizes a fan/paddle tail 1 that is horizontally aligned with the tapered tail section 2, it is not limited to this position. The fan/paddle tail 1 angle may be improved upon to accentuate the action in keeping with the scope and spirit of the claims set forth.

It should he understood of course that the foregoing relates to exemplary embodiments of the invention and that future modifications nay be made without departing from the scope and spirit of the invention as set forth in the claims.

The invention claimed is:

1. A shrimp lure comprising:
An upward plaining, tapered lure head section;
a rounded, tapered body consisting of an upwardly plaining thoracic section, and an downwardly plaining tail section;
continuous, non-jointed section seems;
a triangular fanned, paddle-shaped tail attached to the tail section;
a set of freely moveable antenna stalks attached to either side of the anterior section if the head section;
two spheres placed on the most distal portion of the freely moveable antenna talks;
weight chambers;
internal weights that are smaller in diameter than that of the chambers which cause a rattling or knocking sound when the lure is in motion;
assemblage of internal and external parts glued mechanically using a waterproof liquid adhesive or ultrasonic welding or both;
the body wall thickness being approximately 1.5 mm-2.0 mm and made to provide sufficient integrity and rigidity;
a first lateral side;
a second side opposing the first lateral side;
a top;
a bottom.

2. The shrimp lure of claim 1 possessing an upward plaining, stationary, triangular tail in the aft section of the lure which is constructed with a metallic or non-metallic line attachment ring underneath and immediately fore of the triangular tail.

3. The shrimp lure of claim 1 constructed to possess a metallic ring or a plurality of rings molded into the body and located underneath the fore section at approximately the junction of the head and thoracic body section to accommodate the attachment of single, double or a plurality of hooks;

4. The shrimp lure of claim 1 possessing a single or plurality of individual internal weight chambers that may be positioned to allow for a slightly head down and tail up position when placed in water and may be constructed to assist in a greater or lesser rate of diving.

5. The shrimp lure of claim 1, wherein the placement location and weight size of internal weights allows for a slightly bead down and tail up position hen introduced to water and can positively and negatively affect buoyancy.

6. The shrimp lure of claim 1 wherein the body construction is of a rigid or semi-rigid synthetic, soft, natural or metallic construction, possessing only moderate flexibility that may be transparent, slightly opaque, or completely opaque;

7. The shrimp lure of claim 1, wherein the overall body size is approximately 85 mm-110 mm the body and size is commensurate with the size of the fishing lure.

8. The shrimp lure of claim 1, wherein the lure is accentuated by painting to suitably resemble a live shrimp and may include paint that is natural, fluorescent, or luminescent.

9. The shrimp lure of claim 1, wherein the internal weights may be altered to increase or decrease buoyancy.

10. The shrimp lure of claim 1, wherein dressing of the hook or plurality of hooks may be of a reflective or non-reflective synthetic, natural or metallic fiber to simulate the legs of the shrimp.

11. The shrimp lure of claim 1, wherein the shape of the tail may be modified to assist in a sharper or shallower diving angle.

12. A crawfish lure comprising:
An upward plaining, tampered lure head section;
a rounded, tapered body consisting of an upwardly plaining thoracic section, and an downwardly plaining tail section;
a triangular tail;
a set of freely moveable antenna stalks attached to either side of the anterior section if the head section;
two spheres placed on the most distal portion of the freely moveable antenna stalks;
a plurality of appendages mimicking walking legs originating about either side of said thoracic section that are made to project out and away from said thoracic section toward and below the head section;
2 pincers originating from the posterior portion of the thoracic cavity that project anteriorly toward and underneath the head section;
assemblage of internal and external parts glued mechanically using a waterproof liquid adhesive or ultrasonic welding or both;
the body wall thickness being approximately 1.5 mm-2.0 mm and made to provide sufficient integrity and rigidity;
hollow, internal chambers running the length of the lure;
weights within hollow chambers that are smaller in diameter than that of he chambers which cause a rattling or knocking sound when the lure is in motion;
a first lateral side;
a second side opposing the first lateral side;
a top;
a bottom.

13. The crawfish lure of claim 12 further possessing an upward plaining, stationary, triangular tail in the aft section of the lure which is constructed with a metallic or non-metallic line attachment ring underneath and immediately fore of the triangular tail.

14. The crawfish lure of claim 12 further constructed to possess a second metallic ring located underneath the fore section along the sagittal plain of the lure that is made to accommodate the attachment of single, double or a plurality of hooks;

15. The crawfish lure of claim 12 possessing a single or plurality of individual internal weight chambers that are positioned to assist in a greater or lesser rate of diving by the addition of strategically placed internal metallic weights;

16. The crawfish lure of claim 12, wherein ferrous or non-ferrous metal weights are positioned for a slightly head down and tail up orientation when introduced to water and can be repositioned to positively and negatively affect buoyancy.

17. The crawfish lure of claim 12, wherein the lure is accentuated by painting to suitably resemble a live shrimp or made florescent or luminescent to allow for night fishing.

18. The crawfish lure of claim 12, wherein the shape of the tail and the position of the weights within the weight chamber may be modified to assist in a sharper or shallower diving angle.

19. The crawfish lure of claim 12, wherein the overall body size is approximately 85 mm-110 mm and the body and tail size is commensurate with the size of the fishing lure.

20. The crawfish lure of claim 12, wherein the dressing of the hook or plurality of hooks may be of a reflective or non-reflective synthetic, natural or metallic fiber to simulate the legs of the crawfish.
